(19) United States
(12) Patent Application Publication
(10) Pub. No.: US 2008/0288611 A1
(43) Pub. Date: Nov. 20, 2008

(54) Receiving Apparatus and Receiving System

(76) Inventors: Takashi Toyomura, Yamato (JP); Naoki Mori, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/119,716

(22) Filed: May 13, 2008

(30) Foreign Application Priority Data
May 14, 2007 (JP) 2007-127513

(51) Int. Cl. G06F 15/16

(52) U.S. Cl. 709/219

(57) ABSTRACT

A receiver apparatus capable of retaining the quality of video images received through complexity-reduced small-load processing without having to depend upon its associated transmitter device. In cases where an instruction is made for receiving streaming data in the process of performing the processing of download data, when the loss of such streaming data is predicted to increase in such a way as to go beyond a predetermined degree if both the processing of download data and the processing of streaming data are performed at a time, the receiver performs the processing of the streaming data by giving thereto a higher level of priority.

### INCORPORATION BY REFERENCE

The present application claims priority from Japanese application JP2007-127513 filed on May 14, 2007, the content of which is hereby incorporated by reference into this application.

### BACKGROUND OF THE INVENTION

The present invention relates generally to a receiving apparatus and receiving system, and more particularly to a receiver device capable of securing the quality of images received.

In recent years, video delivery services via networks are becoming widespread. The currently available video delivery techniques include a streaming method and a download method, wherein the former is for reproducing on a real-time basis the contents data to be delivered from a transmitter apparatus while a receiver apparatus is in the process of receiving the data at the same time whereas the latter is for temporarily storing or “saving” the received contents data in the receiver and for performing playback after having acquired an entirety of such contents data.

In the video delivery via networks such as the Internet, one supposed situation is that a user or subscriber, who enjoys the contents of a broadcast program and simultaneously attempts to record another kind of video contents, issues both instructions for streaming and downloading his or her preferred contents at a time. In such an event, it is a must to achieve the delivery of streaming data with enhanced stability. A known technique for doing this is disclosed, for example, in JP-A-2005-210347, which reserves the band of such streaming delivery on a priority basis.

### SUMMARY OF THE INVENTION

Unfortunately, the prior known technique as disclosed in JP-A-2005-210347 has difficulties which follow: an apparatus which performs control for obtaining and retaining the required level of quality must exchange a “special” kind of control information between the apparatus and its associated transmitter apparatus and then perform highly complicated processing tasks. The special control information refers to a method which is designated as an option by the Internet Engineering Task Force (IETF). This information is not always handleable by all transmitters involved. For this reason, the technique taught by JP-A-2005-210347 is not applicable in any way to transmitters which fail to have the handleability of such special control information.

Another problem faced with the prior art is that in the case of both the streaming and the downloading being performed by a one receiver simultaneously, the receiver undesirably increases in workload. This can be said because this receiver keeps on requesting retransmission or “resend” of once-lost download packets.

This invention was made in view of the above-stated technical problems, and its object is to provide a new and improved receiving apparatus capable of obtaining and retaining the quality of received images by readily-executable small-load processing without having to depend upon the type of its associated transmitter apparatus.

To attain the foregoing object, the receiver apparatus is specifically arranged so that it is responsive to receipt of an instruction to receive streaming data during execution of download data processing, for performing a streaming operation on a priority basis in cases where simultaneous execution of the download data processing and streaming data processing would result in the loss of the streaming data becoming larger to an extent that is more than or equal to a predetermined degree.

According to this invention, it is possible to provide a receiver apparatus capable of obtaining and retaining the quality of received images by readily-executable small-load processing while reducing process complexities and avoiding the dependency on the type of its associated transmitter apparatus.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a configuration of a network to which is connected a receiver apparatus in accordance with an embodiment of this invention.

FIG. 2 is a block diagram showing a configuration of the receiver embodying the invention.

FIG. 3 is a flow chart showing a routine procedure of an operation for temporarily interrupting downloading and then restarting it after completion of streaming in case it is determined that the loss of the streaming data becomes greater in excess of a predetermined degree if both the downloading and the streaming are performed at a time in a receiver in accordance with one embodiment of the invention.

FIG. 4 is a diagram showing one example of an on-screen display for selection of whether the download is interrupted or not in a receiver in accordance with first embodiment.

FIG. 5 is a diagram showing one example of an on-screen display for selection of whether the download is restarted or not in the receiver in accordance with the first embodiment.

FIG. 6 is a flowchart of a routine procedure of an operation for temporarily lowering the download rate and for increasing it after completion of the streaming in case simultaneous execution of downloading and streaming operations is judged to result in the streaming data becoming larger in loss in such a way as to go beyond a predetermined degree in a receiver apparatus in accordance with second embodiment.

### DETAILED DESCRIPTION OF THE EMBODIMENTS

Currently preferred embodiments of this invention will be described with reference to the accompanying drawings below. It is noted that the description of these embodiments is illustrative of the invention and is not to be construed as limiting the invention.

### Embodiment 1

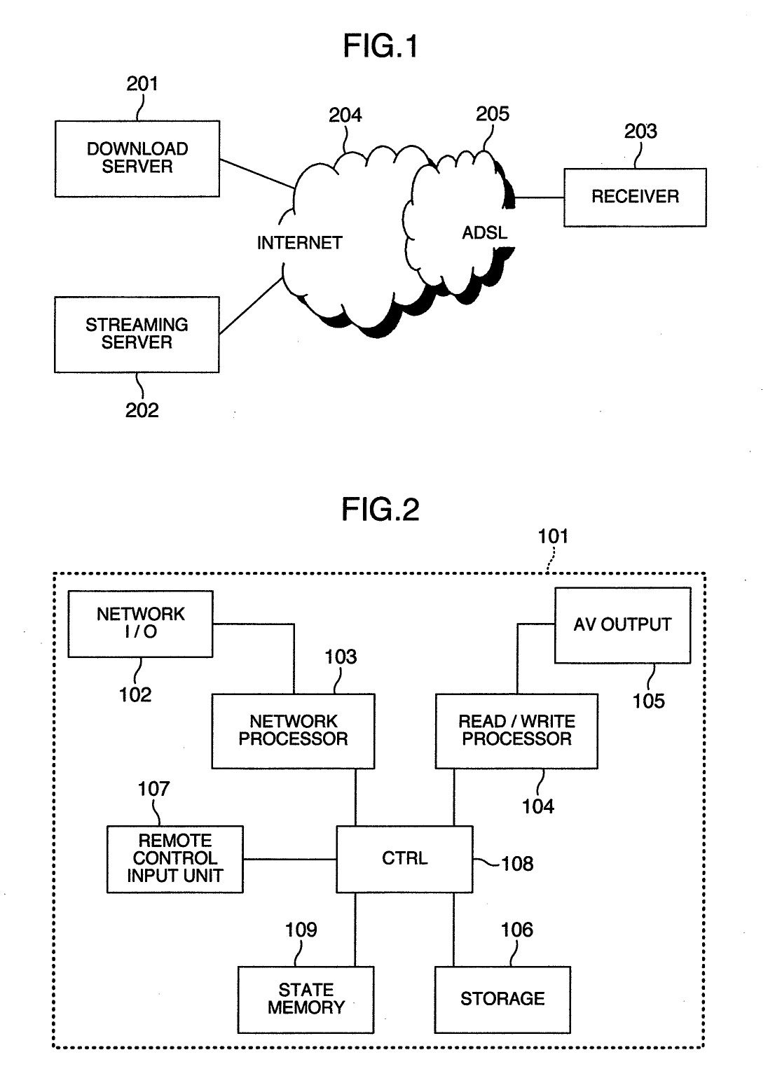

FIG. 1 is a diagram showing one example of the configuration of a network, to which a receiving apparatus 101 is connected. A download server 201 and a streaming server 202 are linked to Internet 204. The receiver 101 is linked to the Internet 204 via an access line, such as an asymmetric digital subscriber line (ADSL) 205 or the like.

When the receiver 101 issues a request for download start-up and sends it to the download server 201, the download server 201 transmits download data to the receiver 101. When this receiver 101 requests the streaming server 202 to start streaming, the streaming server 202 sends streaming data to the receiver.

Although in this embodiment an explanation will be given of a network environment made up of the Internet 204 and ADSL 205, the network configuration embodying the invention should not be limited only to this combination of the Internet and ADSL.

Another example of the access line is a fiber to the home (FTTH) line. A further example is a local area network (LAN) by means of Ethernet™ with the download server 201 and the streaming server 202 being connected together thereby.

FIG. 2 is a diagram schematically showing an exemplary configuration of the receiver 101 in accordance with this embodiment.

The receiver 101 includes a network input unit 102 which transmits and receives data via a network associated therewith. This unit is connected to a network processing unit 103 which performs control and processing of the data available via the network.

The network processing unit 103 is connected to a control unit 108 which provides overall controls by sending instruction signals or the like to respective units making up the receiver 101. The control unit 108 is operatively associated with a record/playback processing unit 104 and an accumulation unit 106 connected thereto, wherein the former performs read/write control and processing of video data whereas the latter stores therein the data available via the network.

The control unit 108 is also connected to a state storage or “memory” unit 109, which stores therein an event of interruption of a download operation in response to receipt of an instruction from the control unit 108 along with a capacity of the data that was downloaded up to the interruption.

The control unit 108 is arranged to determine whether simultaneous execution of download and streaming operations results in the loss of streaming data becoming larger to an extent that is more than or equal to a predetermined degree in accordance with the band of the network. In order to know the network band, a technique is employable for causing a user to preset the type of the network used, such as ADSL or FTTH or else, or its communication speed, also known as the baud rate. Alternatively, it is also preferable to design the receiver 101 so that it recognizes for setup the network type and/or the baud rate in an automated way.

In case the receiver 101 is a portable or handheld device which changes the type of a network for connection in a way depending on in-use locations, the usability for the user is improved by designing the receiver 101 in such a way as to automatically detect and recognize the type of such network. Furthermore, an approach that is also employable is to design the receiver 101 in such a way as to dynamically perform the simultaneous execution of the download and the streaming while taking into account of the band situation of the network at that time, rather than static determination by the network type and the baud rate, to thereby judge whether the loss of the streaming data becomes greater in excess of the predetermined degree. For example, in case the data loss is appreciably large in amount during reception of test data within a fixed length of time period, it is determined that the simultaneous execution of download and streaming is prevented.

It should be noted that the conditions for determining whether the loss of streaming data becomes larger by the predetermined degree or more as a result of simultaneous execution of the streaming and downloading may include, but not limited to, the processing ability of a central processor unit (CPU) as built in the receiver 101 and the storage capacity of a built-in memory of receiver 101.

The receiver 101 is arranged so that during execution of download, the data of contents 1 received by the network input unit 102 is passed via the network processing unit 103 and record/playback processing unit 104 to the accumulation unit 106 and then stored therein.

When a presently established interconnection with the download server 201 is cut off in response to receipt of an instruction from the network processing unit 103, the data of contents 1 is no longer input to the network input unit 102. This results in that the processing for saving the data of contents 1 in the accumulation unit 106 is stopped. At this time, the data of contents 1 that has been acquired up to the interruption is not deleted but stored in the accumulation unit 106. Additionally, information indicating “the download was interrupted” and information as to “data amount of contents 1 gained up to the interruption” are held in the state memory unit 109.

Prior to execution of the download interruption processing, a warning screen for informing a user(s) accordingly may be displayed in the form of a pop-up window. At this time, after having displayed the warning window, the download interruption processing gets started immediately. With this procedure, it is possible to prevent unwanted occurrence of an event that the download is halted while the user is unaware of it.

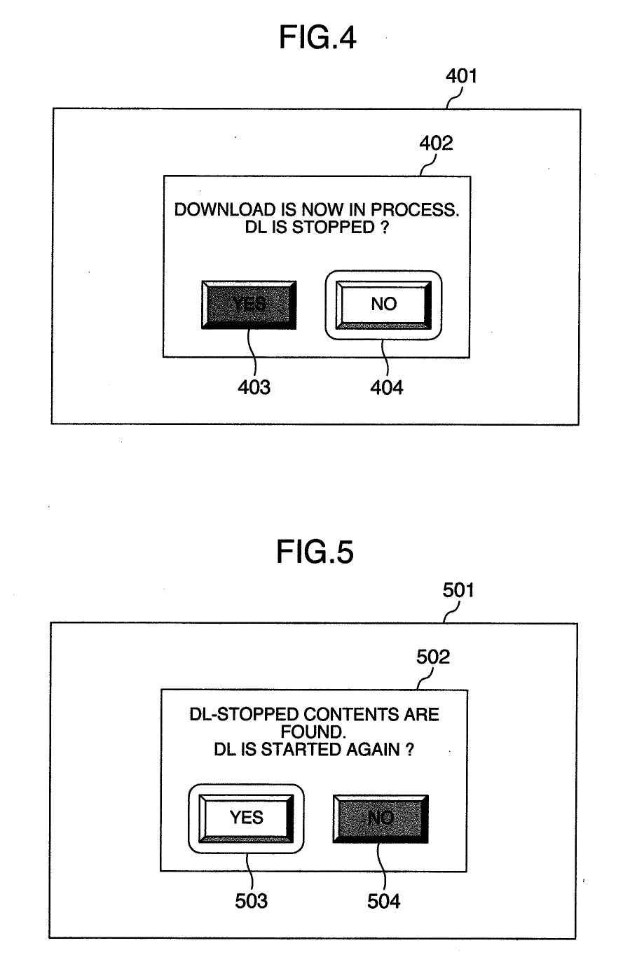

Additionally as shown in FIG. 4, it may also be recommendable to notify the user of the fact that the download is presently in the process of execution prior to execution of the download interruption processing, for enabling the user to choose whether the download is surely interrupted or not. Thus it is possible to avoid the risk of the user's unintentional download interruption otherwise occurring due to his or her erroneous manual operations. This makes it possible to further improve the usability on the user side.

In case the download has been interrupted due to the startup of streaming, when the streaming is ended, a connection with the download server 201 is established in response to receipt of an instruction of the network processor unit 103. Subsequently, the control unit 108 reads from the state memory 109 the data amount of contents 1 acquired up to the interruption of the download and then issues to the download server 201 a request for continuing delivery of the data of the contents from its interrupted portion.

To download the contents 1 from the interrupted portion thereof, the control unit 108 reads from the state memory 109 the data amount of the contents 1 as has been acquired up to the interruption and then sets up a byte range of unreceived data at “Range” header of GET method in the case of hyper text transfer protocols (HTTP) being used. At this time, the information indicating “the download was interrupted” and the information concerning “data amount of contents 1 acquired up to interruption” which are stored in the state memory 109 are deleted.

When a remote control input unit 107 shown in FIG. 2 receives a signal for instruction of the startup of a streaming operation, the control unit 108 establishes a connection with the streaming server 202 in responding to an instruction of the network processing unit 103. Upon startup of the streaming, data of contents 2 is input to the network input unit 102. The data of contents 2 is sent to an audio/video output unit 105 by way of the network processor unit 103 and record/playback processor unit 104; then, video images and sounds of the contents 2 are output from a display device with audio speakers.

Upon completion of the streaming, the data of contents 2 is no longer input to the network input unit 102, and the processing for output of the video images and audio sounds of the contents 2 is terminated.

Note here that prior to the execution of download restart processing, a warning pop-up window may be displayed for notifying the user of such operation state. At this time, immediately after having displayed this warning window, the download restart processing gets started. With this procedure, it is possible to prevent occurrence of an event that the download is restarted while the user is unaware of it.

Additionally, prior to the execution of the download restart processing, it is also permissible to notify the user of the fact that the download has been interrupted as shown in FIG. 5, for enabling the user to choose whether the download is surely restarted or not. Whereby, it is possible to avoid the risk of unintentional execution of the download restart, thereby making it possible to further improve the usability for the user.

Also note that respective files which have been acquired before and after the download interruption may be managed as separate files; alternatively, these files may be managed as a single file. By managing them in the form of separate files, it becomes possible for the user to view images and/or listen to audio sounds of part of the contents that have been gained before the interruption within a time period between the download restart and termination. This contributes to further improvements in usability for the user.

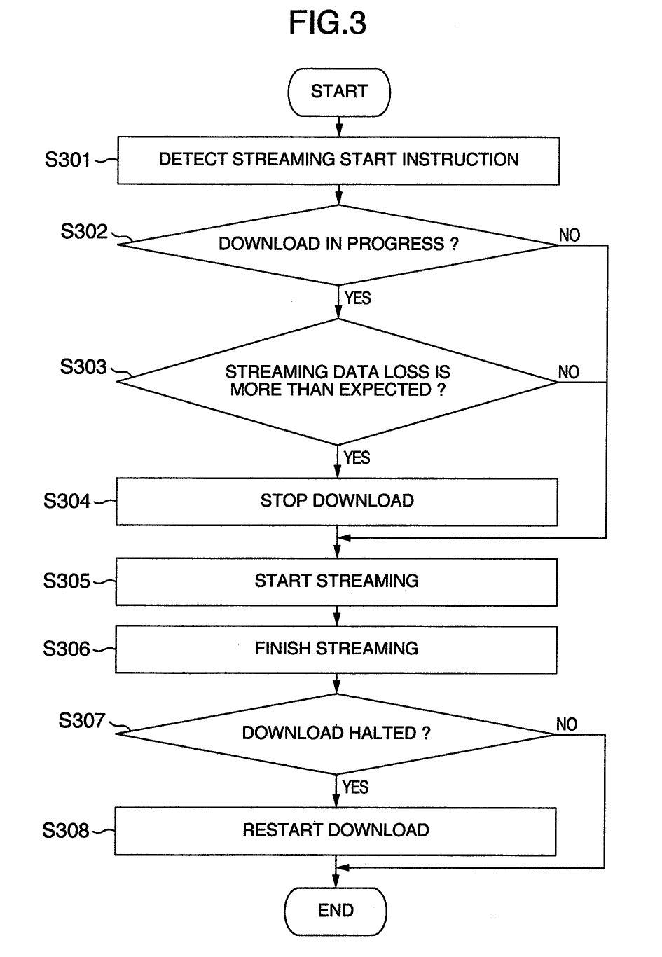

An explanation will next be given, using FIG. 3, of the processing procedure for retaining the quality of video images in a case where the user issues an instruction to view and listen to the contents 2 of the streaming server 202 while the receiver 101 is performing download of the contents 1 from the download server 201.

When the remote control input unit 107 receives a streaming start signal which was output from a remote controller (not shown), the control unit 108 detects that the streaming startup was instructed at step S301 of FIG. 3. Then, the control unit 108 determines whether the download is presently in execution at step S302. If it is judged that the download is not in execution, that is, if NO at step S302, then go to step S305 which starts a streaming operation.

Alternatively, if it is judged that the download is in progress, i.e., if YES at step S302, then go to step S303 which determines whether the loss of streaming data becomes larger to an extent that is more than or equal to a predetermined degree as a result of simultaneous execution of the download and the streaming by taking into consideration the band of the network, to which the receiver 101 is connected. If it is determined that the loss of streaming data does not become larger by the predetermined degree due to such simultaneous execution of the download and the streaming, i.e., if NO at step S303, then the streaming gets started while at the same time continuing the download operation.

If it is decided that the loss of streaming data becomes larger to go beyond the predetermined degree due to the simultaneous execution of the download and the streaming, i.e., if YES at step S303, then proceed to step S304 which performs interruption processing of the download, followed by step S305 which causes the streaming to get started thereafter. When the connection with the streaming server 202 is cut off in accordance with an instruction of the network processor unit 103 at step S306, the control unit 108 issues an inquiry to the state memory 109 and then determines whether the download is interrupted prior to the startup of the streaming at step S307. If it is determined that the download is not interrupted before the startup of streaming, i.e., if NO at step S307, then exit the routine procedure (at END) while changing a present on-screen display to a specific service screen.

When it is judged that the download has been interrupted prior to the startup of the streaming at step S307, i.e., if YES at this step, then go to step S308 which performs restart processing of the download operation. Thereafter, transit to a specific service screen display session (END).

Examples of the service screen include, but not limited to, a television (TV) broadcast display screen, browser screen, and TV program timer recording list screen. The kind of this service screen to be displayed in this session may be selected by the user according to his or her preference, when the need arises.

In accordance with the above-stated apparatus and system embodying this invention, it is possible to prevent data congestion on the access line, thereby making it possible to retain an increased level of streaming image quality. In addition, with the use of simplified processing for download interruption only, it is possible to obtain the intended effects for all types of currently available servers which are designed to employ the principles of the illustrative embodiment of this invention. Furthermore, by eliminating execution of resend processing of the download, it is possible to reduce the load of CPU and/or the used storage capacity of the built-in memory. This makes it possible to configure products by use of low-price CPUs and memory modules.

It is noted that although in this embodiment the specific case has been discussed where a single receiver device attempts to perform more than two different kinds of services at a time, the invention may also be applicable to other cases where a plurality of receivers which use the same access line attempt to perform their own services, respectively. An example of such cases is as follows: while a certain receiver is performing download of the contents 1 from the download server 201, when another receiver which uses the same access line issues an instruction for viewing and listening to the contents 2 of the streaming server 202, the download may be interrupted after having obtained permission of the users of the both receivers by means of a warning screen or message which is visually provided to both of them.

Additionally, although in this embodiment one specific case is explained where the downloading and the streaming are performed simultaneously, this is not to be construed as limiting the invention in terms of the kinds of services and number. Other examples of the service kinds which are alternatively employable are an email send/receive service and a web browsing service over the Internet. The service delivery route should not exclusively be limited to the network only and may also be modified to use in combination the network for download purposes and the existing over-the-air TV broadcast channels. The processing technique of this invention is also applicable in cases where simultaneous execution of download via the network and TV program watching would result in an increase in receiver workload, which leads to the lack of an ability to perform the task required. Also note that if the processing of the invention is implemented in cases where the quality required is no longer retainable due to the start of a new service without regard to the service number, it is possible to further improve the usability for users.

### Embodiment 2

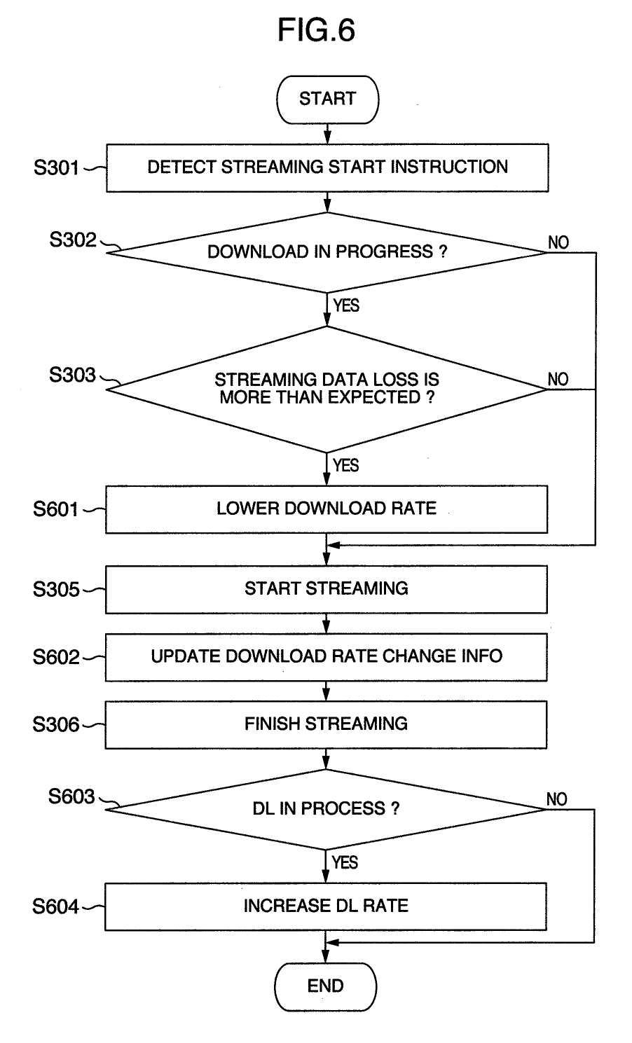

Next, an explanation will be given of a second embodiment of this invention with reference to FIG. 6. Regarding the same parts of this embodiment 2 as those of the above-stated embodiment 1, explanations thereof will be eliminated herein. Only its different parts will be described in detail below.

The control unit 108 is arranged in a manner which follows: during execution of download of contents, upon receipt of an instruction to start streaming, this control unit performs the processing for execution of download and streaming operations simultaneously while reducing the download speed of such contents to be downloaded.

One approach to lowering the download rate, which is employable in the case of transmission control protocols (TCP) being used for example, is to set a small value in a window size field of TCP header to thereby reduce the amount of data to be sent together at a time. Another employable approach is to set a small value in an option field of the TCP header as the maximum segment size (MSS) to thereby lessen the amount of data being sent at a time. If this is the case, the information indicating “the download rate was reduced” is held in the state memory 109.

Note that a warning screen for notifying the user of such situation may be visually displayed prior to the download rate reduction. At this time, the download rate is reduced immediately after having displayed such warning screen. With this procedure, it is possible to prevent unwanted occurrence of the event that the download is slowed before the user becomes unaware of it.

Also note that it is permissible to notify the user of the fact that the download is presently in progress prior to actual reduction of the download rate, for giving the user a chance to choose whether the download is surely reduced or not. This makes it possible to avoid the risk of unintentional reduction of the download rate, thereby enabling further improvement of the usability for the user.

In case the download and the streaming are being executed simultaneously, the control unit 108 executes the processing of step S602 periodically or non-periodically. At step S602, the download rate change information that is held in the state memory 109 is updated. For example, when the download is ended in the process of viewing and listening of the streaming, the information of “download rate was reduced” which is held in the state memory 109 is deleted.

In case the download and the streaming are being performed simultaneously, the control unit 108 causes the download rate to increase upon termination of the streaming.

An approach to increasing the download rate in the case of using TCP as an example is to set a large value in the window size field of TCP header to thereby increase the amount of data to be sent together at a time. Another employable approach is to set a large value as MSS by use of the option field of TCP header to thereby increase the amount of data being sent together. At this time, the information of “download rate was reduced” which is held in the state memory 109 is deleted.

Before the download rate is increased, it is a good ideal to display a warning screen for notifying the user of such situation. At this time, let the download rate increase immediately after having displayed the warning screen. Alternatively, before the download rate increase, it is also permissible to notify the use of the fact that the download rate has been decreased previously, for giving the user a chance to choose whether the download rate is truly increased or not.

It is also recommendable to provide an arrangement for enabling the user to view and listen to part of the contents that have already been acquired even prior to completion of the download. With such the arrangement, it is possible to further improve the usability for the user.

FIG. 6 is a flow diagram of an image quality securement processing procedure in a case where the user issues an instruction to view and listen to the contents 2 of the streaming server 202 in the process of performing download of the contents 1 from the download server 201 in the receiver apparatus of this embodiment.

At steps S301 to S303 shown in FIG. 6, the same or similar processes are performed as those of the embodiment 1.

If YES at step S303, that is, when it is judged that simultaneous execution of the downloading and the streaming results in the loss of streaming data becoming larger to an extent that goes beyond a predetermined level, proceed to step S601 which performs processing for decreasing the download rate.

Then, go to step S305 which continues execution of the download and, at the same time, performs the streaming while updating the download rate change information.

Thereafter, upon completion of the streaming at step S306, the control unit 108 determines whether the download is presently in progress at step S603. If NO at this step, i.e., when it is judged that the download is not in progress, transit to a specific service screen (END). Examples of the service screen include, but not limited to, a TV broadcast display screen, browser screen, and TV program timer record list. The kind of this service screen may be selected by the user according to his or her preference. If YES at step S603, i.e., when it is judged that the download is presently in progress, go to step S604 which performs the processing for increasing the download rate. After having acquired the entire data of the contents 1, exit the routine of FIG. 6 as indicated by “END” while changing the on-screen display to a specific service screen.

Although in this embodiment the processing for reducing the download rate is executed without fail when it is judged that the download is in progress at step S302, this process may be modified in such a way as to decrease the download rate after an attempt was made to determine whether the download rate should be changed in accordance with network environments and the processing ability of the receiver apparatus.

More specifically, at step S601, it is judged whether the download rate should be changed or not. If it is judged that this rate is to be changed, then decrease the download rate. Alternatively, if it is judged that there is no need to vary this rate then continue the download at a present rate without change. In this case, at step S604, it is necessary for the control unit 108 to issue an inquiry to the state memory 109 for determining whether the download rate was changed prior to startup of the streaming. In case the download rate is varied before the startup of the streaming, let the download rate increase; if not, continue the download operation at the unchanged rate. At step S604 also, in a similar way to step S601, reconsideration may be taken as to whether the download rate should be changed or not in view of the network environments and the receiver processability.

According to the above-stated receiver apparatus and system embodying the invention, it is possible to prevent data congestion on the access line to an extent that is able to retain the streaming image quality required, thereby making it possible to attain an increased level of streaming image quality. In addition, by continuously acquiring even little amounts of the data of contents 1 once at a time during viewing and listening to the streaming contents, it is possible to shorten the length of a time as taken to perform the download after completion of the streaming session.

It should be noted that although in this embodiment one specific case has been explained where a single receiver apparatus attempts to perform more than two different kinds of services at a time, the invention may also be applicable to other cases where a plurality of receivers which use the same access line attempt to perform their own services, respectively. An example of such cases is as follows: while a certain receiver is downloading the contents 1 from the download server 201, when another receiver which uses the same access line issues an instruction to view and listen to the contents 2 of the streaming server 202, the download rate may be decreased after having obtained permission of the users of both receivers by means of a warning screen or message which is visually provided to both of them.

Also note that the constituent blocks shown in FIG. 2 should not always be structured from respective separate hardware modules when the illustrative receiver apparatus is reduced to practice as a commercially available product. For example, the network processor unit 103 and record/playback processor unit 104 as well as the control unit 108 and state memory 109 may be integrated together into a large scale integrated (LSI) chip in accordance with design specifications and design requirements.

Furthermore, although in the embodiment 1 and embodiment 2 one specific case has been discussed where an instruction is made for starting the streaming in the process of executing the download, there is a reverse case where the download gets started by a timer during execution of the streaming. In such case, it is possible to retain the streaming image quality by limiting the download rate or by delaying the startup of the download until the streaming session is ended—that is, letting it go into standby.

It should be further understood by those skilled in the art that although the foregoing description has been made on embodiments of the invention, the invention is not limited thereto and various changes and modifications may be made without departing from the spirit of the invention and the scope of the appended claims.

1. A receiving apparatus comprising:
an instruction input unit for input of an instruction to receive data externally;
a data input unit for input of first service data and second service data to be externally sent in accordance with the instruction of said instruction input unit; and
a control unit operative to perform control and processing of the data as input to said data input unit, wherein
in a case where an instruction to receive the second service data is input to said instruction input unit while said control unit is processing the first service data being input to said data input unit in accordance with the instruction as input to said instruction input unit, when said control unit determines that the processing of the second service data becomes slower to an extent that is equal to or more than a predetermined degree as a result of said control unit's simultaneous execution of the processing of the first service data and the reception of the second service data, said control unit performs processing of the second service data with priority being given thereto.

2. The receiving apparatus according to claim 1, wherein upon interruption or restart of the data processing, a situation thereof is notified to a user of either one of receiving apparatuses or to users of both receiving apparatuses.

3. A receiving apparatus comprising:
an instruction input unit for input of an instruction to receive data externally;
a data input unit for inputting externally transmitted download data and streaming data; and
a control unit for performing control and processing of the data as input to said data input unit, wherein
in case an instruction to receive the streaming data is input to said instruction input unit while said control unit is processing the download data being input to said data input unit in accordance with the instruction as input to said instruction input unit, when said control unit determines that a loss of streaming data becomes larger to an extent that is equal to or more than a prespecified degree as a result of said control unit's simultaneous execution of reception of the download data and reception of the streaming data, said control unit interrupts the reception of the download data and performs the reception and processing of the streaming data.

4. The receiving apparatus according to claim 3, wherein said control unit determines whether the loss of the streaming data becomes larger to an extent that is equal to or more than the prespecified degree by simultaneously receiving the download data and the streaming data based on a band of a network.

5. The receiving apparatus according to claim 4, further comprising a state storage unit for storing therein an archival record of processing tasks executed by said control unit, wherein in case an instruction to receive the streaming data is input to said instruction input unit while said control unit is processing the download data being input to said data input unit in accordance with the instruction as input to said instruction input unit, when said control unit determines that the loss of streaming data becomes larger to an extent that is equal to or more than the prespecified degree as a result of said control unit's simultaneous execution of reception of the download data and reception of the streaming data, said control unit interrupts the reception of the download data while letting information as to interruption processing be stored in said state storage unit and reads the information as to the download interruption processing out of said state storage unit after having completed the reception and processing of the streaming data to thereby restart the reception and processing of the download data.

6. The receiving apparatus according to claim 5, further comprising an accumulation unit for storing the download data while causing part of the data to be replayable within a time period between the download restart and completion.

7. The receiving apparatus according to claim 5, wherein upon interruption or restart of download, such a situation is notified to a user or users.

8. The receiving apparatus according to claim 5, wherein upon interruption or restart of interruption of data processing, such a situation is notified to a user of either one of receiving apparatuses or users of both of the receiving apparatuses.

9. The receiving apparatus according to claim 3, further comprising a state storage unit for storing therein an archival record of processing tasks executed by said control unit, wherein in case an instruction to receive the streaming data is input to said instruction input unit while said control unit is processing the download data being input to said data input unit in accordance with the instruction as input to said instruction input unit, when said control unit determines that the loss of streaming data becomes larger to an extent that is equal to or more than the prespecified degree as a result of said control unit's simultaneous execution of reception of the download data and reception of the streaming data, said control unit interrupts the reception of the download data while letting information as to interruption processing be stored in said state storage unit and reads the information as to the download interruption processing out of said state storage unit after having completed the reception and processing of the streaming data to thereby restart the reception and processing of the download data.

10. The receiving apparatus according to claim 9, wherein, part of the download data being presently stored in said state storage unit is replayable within a time period between the download restart and completion.

11. The receiving apparatus according to claim 9, wherein upon interruption or restart of download, such a situation is notified to a user or users.

12. The receiving apparatus according to claim 9, wherein upon interruption or restart of interruption of data processing, such a situation is notified to a user of either one of receiving apparatuses or users of both of the receiving apparatuses.

13. A receiving apparatus comprising:
an instruction input unit for input of an instruction to receive data externally;
a data input unit for receiving externally transmitted download data and streaming data; and
a control unit for performing control and processing of the data as input to said data input unit, wherein
in case an instruction to receive the streaming data is input to said instruction input unit while said control unit is receiving the download data being input to said data input unit in accordance with the instruction as input to said instruction input unit, when said control unit determines that a loss of streaming data becomes larger to an extent that is equal to or more than a prespecified degree as a result of said control unit's simultaneous execution of reception of the download data and reception of the streaming data, said control unit reduces a download rate and performs simultaneous reception of the download data and the streaming data along with processing thereof.

14. The receiving apparatus according to claim 13, wherein said control unit determines whether the loss of streaming data becomes greater to an extent that is equal to or more than the prespecified degree as a result of execution of simultaneous execution of the download data and the streaming data at a rate of download being presently performed based on a band of a network.

15. The receiving apparatus according to claim 14, further comprising a state storage unit for storing therein an archival record of processing tasks executed by said control unit, wherein in case an instruction to receive the streaming data is input to said instruction input unit while said control unit is processing the download data being input to said data input unit in accordance with the instruction as input to said instruction input unit, when said control unit determines that the loss of streaming data becomes larger to an extent that is equal to or more than the prespecified degree as a result of said control unit's simultaneous execution of reception of the download data and reception of the streaming data, said control unit reduces the rate of the download data while storing information as to reduction of the download rate in said state storage unit and then reads the information as to the download rate reduction out of said state storage unit after completion of the reception and processing of the streaming data to thereby increase the download rate.

16. The receiving apparatus according to claim 13, further comprising a state storage unit for storing therein an archival record of processing tasks executed by said control unit, wherein in case an instruction to receive the streaming data is input to said instruction input unit while said control unit is processing the download data being input to said data input unit in accordance with the instruction as input to said instruction input unit, when said control unit determines that the loss of streaming data becomes larger to an extent that is equal to or more than the prespecified degree as a result of said control unit's simultaneous execution of reception of the download data and reception of the streaming data, said control unit reduces the rate of the download data while storing information as to reduction of the download rate in said state storage unit and then reads the information as to the download rate reduction out of said state storage unit after completion of the reception and processing of the streaming data to thereby increase the download rate.

17. The receiving apparatus according to claim 13, wherein upon interruption or restart of download, such a situation is notified to one or more users.

18. A receiving system comprising:
a first receiver device including a first instruction input unit for input of an instruction to receive externally incoming data, a first data input unit for input of download data and streaming data to be externally transmitted in accordance with the instruction of said first instruction input unit, and a first control unit for performing control and processing of the data being input to said first data input unit; and
a second receiver device having a second instruction input unit for input of an instruction to receive externally incoming data, a second data input unit for input of download data and streaming data to be externally sent forth in accordance with the instruction of said second instruction input unit, and a second control unit for performing control and processing of the data as input to said second data input unit, wherein
in a case where an instruction to receive the streaming data is input to said second instruction input unit while the first receiver is processing service data being input to said first data input unit by said first control unit, when said second control unit of the second receiver determines that a loss of streaming data becomes larger by a prespecified degree or more as a result of execution of reception of the streaming data, said second receiver performs the reception and processing of the streaming data with priority being given thereto.
